(19) United States
(12) Patent Application Publication
(10) Pub. No.: US 2013/0206703 A1
(43) Pub. Date: Aug. 15, 2013

(54) GRAVITY SEDIMENTATION PROCESS AND APPARATUS

(71) Applicants: Jianhua Du, Mawson Lakes (AU); Arthur Richard McLoughlin, Panorama (AU); Roger Smart, Mawson Lakes (AU)

(72) Inventors: Jianhua Du, Mawson Lakes (AU); Arthur Richard McLoughlin, Panorama (AU); Roger Smart, Mawson Lakes (AU)

(73) Assignees: High Power Ultrasonics Pty., Ltd., Crafers (AU); CRC Care Pty., Ltd., Mawson Lakes (AU)

(21) Appl. No.: 13/699,537

(22) PCT Filed: May 25, 2011
(86) PCT No.: PCT/AU11/00633

§ 371 Date: Jan. 22, 2013

(30) Foreign Application Priority Data
May 25, 2010 (AU) 2010902284
Jun. 4, 2010 (AU) 2010902469

(51) Int. Cl. C02F 1/36

(52) U.S. Cl. CPC C02F 1/36
USPC 210/748.05; 210/251

(57) ABSTRACT

A gravity sedimentation process for the treatment of a slurry in a thickener to separate a solid from a liquid, the thickener having, at steady-state, a hindered settling zone and a compression zone, the process including the application of an effective amount of ultrasonic energy to the slurry in a transition zone within the hindered settling zone.

### RELATED APPLICATIONS

This international patent application claims priority from Australian provisional patent applications 2010902284 and 2010902469, the specifications of which are hereby incorporated by reference.

### FIELD OF THE INVENTION

The present invention relates to processes for the separation of suspended solid particles from a liquid by gravity settling. These processes are generally conducted in equipment often referred to simply as “thickeners”, such thickeners being regarded as crucial equipment in, for example, a wide range of mineral processing applications, such as in the coal industry and in heavy mineral and base metal mineral separations. Indeed, the present invention is envisaged to find most use in the field of mineral processing.

### BACKGROUND OF THE INVENTION

Billions of tonnes of tailings waste are produced in mining operations every year from minerals separation processes. Huge volumes of slurry streams containing, for example, a clay content in the order of 2 to 4 wt % are disposed into tailings dams and landfill; disposal of these wastes is costly and potentially environmentally problematic.

Indeed, tailings waste usually contains very high volumes of liquid (as much as 60% to 95% of the tailings will often be water) that could be recycled or re-used. Furthermore, expenditure for tailings impoundments includes the costs of land acquisition, perimeter wall construction, drains and slurry pipelines. Environmentally, impoundments can lead to liquid loss through seepage and evaporation, dust and loss of visual amenity. Clay settling in tailings dams can be very slow, often requiring months before liquid separation and solids removal is possible, and costly chemical treatment may be required to allow continual dumping. Therefore, the mining industry is always looking at ways to reduce the amount of liquid entrained in the tailings produced during their traditional mineral separation processes, and even small percentage improvements can lead to significant benefits in the reduction of operating costs and in the recovery of valuable minerals lost in thickener underflows.

In these traditional mineral separation processes, slurries (suspensions comprising liquids carrying suspended solid particles) are often required to be subjected to gravity sedimentation to separate solid particles from a supernatant liquid. Typically, this separation is accomplished by continuously feeding a slurry to a large cylindrical vessel (a thickener) where the suspended solid particles are allowed to gravity settle and form a sludge (a settled bed) on the bottom of the thickener. The settled bed is removed from the bottom of the thickener as underflow for further processing or disposal as tailings in a tailings storage dam, while the supernatant liquid is removed as overflow for further clarification, disposal or re-use.

A thickener is usually a vertically oriented, cylindrical vessel of a size determined by the amount of slurry to be treated in a given unit of time. The central portion of the bottom of a thickener is usually conical and slopes downwardly towards an underflow discharge port. The feed slurry is fed into the upper part of the thickener usually through a central feed-well, with the solid particles settling towards the bottom and supernatant liquid rising to the top to overflow via a peripheral launder. A rake mechanism is normally provided, having a rake located at or near the bottom of the thickener that can be rotated (often driven from above) at a speed suitable to produce a desired solid-liquid ratio (often defined in terms of a solids density) in the underflow. The rake speed is usually determined by the compressive yield stress of the settled bed.

The settling process is usually expedited by the addition of a flocculant to the slurry before being fed into the thickener (such as via the feed-well), the flocculant being of a type (often with a polymeric molecular structure) which agglomerates with the suspended particles in the slurry to form aggregated clusters of particles simply referred to as aggregates or flocs.

It is generally accepted that there are four distinct zones within a thickener when operating at steady-state. At the top there is a clear liquid zone, being a zone comprising the supernatant liquid that has been separated from solid particles in the slurry. Below that is a settling zone of aggregates of relatively uniform consistency and density that provide a permeability that permits the percolation of the liquid up towards the clear liquid zone and the transport of the densifying solid particles downwards towards the underflow. With flocculant absorbed on to the surface of the solid particles, in the settling zone the size and density of the forming aggregates starts to increase and settle towards the bottom of the zone.

The settling zone is often itself regarded as having an ‘upper’ free settling zone and a ‘lower’ hindered settling zone. In the free settling zone, un-contacted aggregates can settle freely, normally at quite high settling rates that in practice can be as high as 10 m/h. However, when these individual aggregates settle into the hindered settling zone the settling rates dramatically slow down.

Below the settling zone is a compression zone. With a rake rotating through the thickener, part of the trapped water in the hindered settling zone gets released, resulting in a settled bed compressing and consolidating in the compression zone. Typically, the top of the settled bed (often referred to as “the settled bed level”) will form at or near the boundary between the compression zone and the hindered settling zone. Indeed, the settled bed level is regarded by some skilled addressees as defining the boundary between the compression zone and the hindered settling zone.

The present invention aims to provide both gravity sedimentation apparatus and a gravity sedimentation process able to increase the settling rate within a thickener in a manner to improve the settled bed solid density.

Before turning to a summary of the present invention, it must be appreciated that the above description has been provided merely as background to explain the context of the invention. It is not to be taken as an admission that any of the material referred to was published or known, or was a part of the common general knowledge in Australia or elsewhere.

### SUMMARY OF THE INVENTION

The present invention is based on the surprising discovery that the primary reason for retention of liquid (such as water) in tailings (such as kaolin clay-based tailings) is the formation, after flocculant addition, in a thickener's hindered settling zone of a honeycomb-like bridged network of edge-edge chains of solid particles. It has been found that this network traps liquid both in inter-aggregate volumes between the chains and in intra-aggregate volumes within the chains. The present inventors have recognised that, if it was possible to induce restructuring of these aggregates and chains, it may be possible to achieve increased release of liquid from both sites, to thereby increase the settling rate within a thickener in a manner that would improve the settled bed solid density.

In relation to inducing restructuring in these aggregates and chains, the present inventors recognised that raking assists dewatering in the early stages of a gravity sedimentation process (such as in the first 10 to 15 minutes) by breaking the larger floc networks to form smaller flocs and by causing some aggregate restructuring to form denser flocs. However, the smaller flocs actually create a stronger network structure that resists further self-weight compression, and continuous raking only rolls the smaller floc network around in the compression zone without breaking them again.

Importantly, the present inventors recognised that to successfully release water from the inter-aggregate volumes between the chains and the intra-aggregate volumes within the chains, the water should be released before the compression zone where the settled bed will have fully consolidated. In this respect, the present inventors recognized that the hindered settling zone provided opportunities for improvement in settling rates and bed densities, and that within the hindered settling zone there surprisingly is a transition zone (adjacent the compression zone) that presents ideal opportunities for the present invention.

The present invention thus provides a gravity sedimentation process for the treatment of a slurry in a thickener to separate a solid from a liquid, the thickener having, at steady-state, a hindered settling zone and a compression zone, the process including the application of an effective amount of ultrasonic energy to the slurry in a transition zone within the hindered settling zone.

The present invention also provides a thickener for gravity sedimentation in the treatment of a slurry to separate a solid from a liquid, the thickener having, at steady-state, a hindered settling zone and a compression zone, the thickener including an ultrasonic generator for applying an effective amount of ultrasonic energy to the slurry in a transition zone within the hindered settling zone.

Further, the present invention provides a gravity sedimentation process for the treatment of a slurry in a thickener to separate a solid from a liquid, the thickener having, at steady-state, a hindered settling zone and a compression zone, the process including the application of an effective amount of ultrasonic energy to the slurry in a transition zone within the hindered settling zone, wherein the application of an effective amount of ultrasonic energy to the slurry in the transition zone breaks a self-supporting structure of aggregates forming, before a honeycomb-like bridged network of edge-edge chains of solid particles fully consolidates in the compression zone.

Indeed, it is the application of an effective amount of ultrasonic energy to the slurry in the transition zone that has been found to break the self-supporting structure of the aggregates as it is forming, before the honeycomb-like bridged network of edge-edge chains of solid particles mentioned above fully consolidates in the compression zone of the settled bed.

The application of ultrasonic energy within the transition zone of the hindered settling zone is to be distinguished from the application of ultrasonic energy to the slurry prior to addition of the slurry to the thickener, whether that application be in conjunction with flocculant addition or not, or before/after flocculant addition. The careful identification of the transition zone and the appropriate application of the ultrasonic energy within that zone, provides unexpected advantages and benefits over the application of the ultrasonic energy at other locations. In this respect, the transition zone is preferably adjacent the compression zone and immediately above the settled bed level, where it has been found that the application of an effective amount of ultrasonic energy to the slurry is particularly advantageous.

In a preferred form, the ultrasonic energy is ideally applied only through the transition zone within the hindered settling zone, and not additionally through other zones. This suggests the application of the ultrasonic energy from the sidewall of the thickener adjacent the transition zone, rather than from above or below the thickener. Indeed, it is envisaged that the easiest way to identify this transition zone will simply be to locate the settled bed level (as mentioned above, generally regarded as being the boundary between the compression zone and the hindered settling zone) once the thickener is operating at steady-state (without the application of any ultrasonic energy) and apply the ultrasonic energy from the settled bed level and above. With this in mind, it is envisaged that the ultrasonic energy will be applied at this location by fixing ultrasonic transducers around the inside or outside of the thickener wall at the height of the transition zone, the transducers being connected to a control unit which can adjust the power output of the transducer to a desired power density.

In terms of the ideal location of such transducers, it will be appreciated that the use of an immersible transducer within the thickener would be preferred in order to increase the efficiency of delivering ultrasonic energy to the transition zone, however this would introduce extra technical difficulties due to the need to avoid hindering the operation of the rake. On the other hand, while location of the transducers outside the thickener would be an easier practical exercise, the efficiency of delivery of the ultrasonic energy to the transition zone would likely be lower.

In terms of locating the settled bed level, apart from the need to locate that level for the purposes of the present invention, incorrect recognition of the location of the settled bed level in thickeners can lead to liquid being drawn out through the underflow, solids spilling over in the overflow or incorrect flocculation (where used), all of which give rise to wasted flocculant or reprocessing costs. Different techniques can be utilised to determine a thickener's settled bed level (and thus to determine the start of the hindered settling zone and of the transition zone mentioned above), such as the determination of a theoretical settled bed level based on the calculation of the average density of a constant height using a hydrostatic pressure sensor, the use of a turbidity sensor, either at a fixed height or attached to a motorised cable spool, or the use of a buoyancy-based electromechanical system. To overcome issues related to the use of rakes in thickeners, device measurement cycles can be automated so that measurement takes place in between rake rotations.

The amount of ultrasonic energy applied to the slurry is regarded as being effective once the ultrasonic energy breaks the self-supporting structure of the slurry aggregates, being the point at which inter-aggregate water is released without significant restructuring of the aggregates. The actual amount of ultrasonic energy to be applied will thus be determined on a thickener-by-thickener basis and will be dictated by various operating conditions. For example, a slurry comprising highly crystalline particles (such as particles having a crystallinity greater than about 0.7 on the Hinkley index) may require greater amounts of ultrasonic energy to be applied to achieve an equivalent improvement in settling rate (equivalent to, say, a slurry comprising less crystalline particles) due to highly crystallised particles tending to have higher normal settling rates.

Further, it has been found that a slurry with, for example, 8 wt % solids content will require higher ultrasonic energy levels in order to break the self-supporting structure as the higher solids content tends to dissipate ultrasonic energy. Indeed, liquid viscosity and temperature can also influence the dissipation of ultrasonic energy, as can flocculant types and dosage levels In this respect, flocculant types and dosage levels tend to impact on the rigidness of the flocculated structures formed, thus requiring adjustment of ultrasonic energy levels.

For example, it is envisaged that the intensity of the ultrasonic energy applied to the slurry will preferably be in the range of 1.0 to 100.0 watts/litre (W/l), although in some cases higher still, preferably operating at frequencies in the range of from 20 to 450 Hz. In a preferred form, the intensity of the ultrasonic energy applied to the slurry will preferably be in the range of 1.0 to 50.0 watts/litre (W/l), or more preferably will be in the range of 1.0 to 10.0 watts/litre (W/l).

### DESCRIPTION OF PREFERRED EMBODIMENTS

Having briefly described the general concepts involved with the present invention, various preferred embodiments will now be described, with reference to the examples outlined below, that are in accordance with the present invention. However, it is to be understood that the following description is not to limit the generality of the above description.

After analysis of the dynamics of a settling process in a raked bed in a thickener from start-up to steady-state, it was found that the location of the settled bed level is different in the initial stages of raking from the final stages of raking. Significant changes of settled bed level were observed in the first 10 to 15 minutes of raking, and after this time the bed level did not change significantly. The present inventors thus concluded that raking can only effectively help dewatering in the first stage of raking (usually those first 10 to 15 minutes, depending on the sample) by opening the cellular network of the big flocs. Then, the flocs reconsolidate, forming smaller trapped volumes and a strongly resistant self-supporting network structure, which still traps water within the flocs.

For example, after 10 minutes raking of one sample of a flocculated kaolin suspension, the settled bed level almost stabilized and no significant change of the settled bed level after this point was observed, probably due to the smaller flocs forming a stronger network structure that resists the self-weight compression. Continuous raking only revolved the smaller flocs around the vessel or rake frame without breaking them open again.

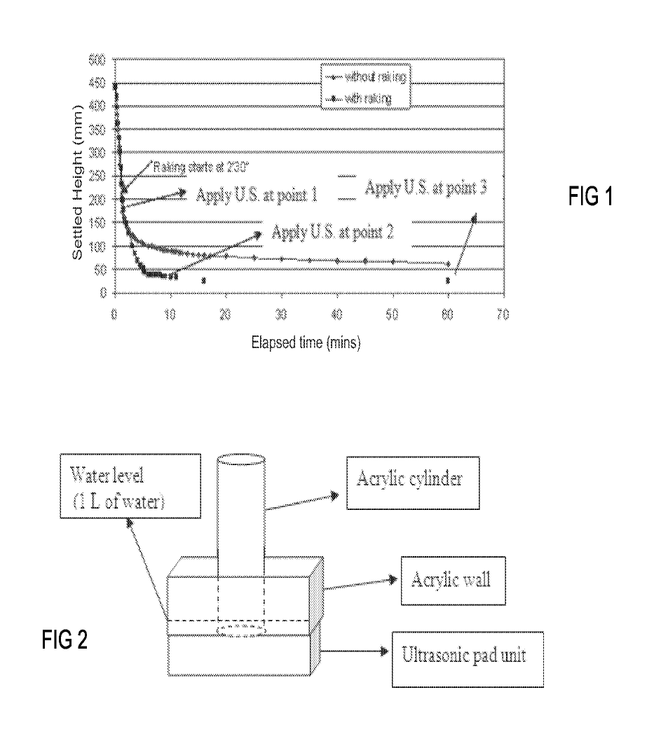

Based on these results, ultrasonic energy was applied at different stages of the settling process, simultaneously with raking, to open the network structure and release entrapped water. Three points for the application of ultrasonic energy were selected as shown in FIG. 1:
Early in the hindered settling zone (Point 1)—see Comparative Example 1 below;
At a point that was regarded as being close to the boundary between the compression zone and the hindered settling zone (and thus being close to the settled bed level), being within a transition zone adjacent to the compression zone but within the hindered settling zone (Point 2)—see Example 1 below.
Within the compression zone itself (Point 3)—see Comparative Example 2 below.

### Experimental Setup—Apparatus and Samples

The ultrasonic treatments described below with reference to the examples were conducted using a 1200 W, 20 kHz flat pad unit, appropriately modified. Modification included construction of a bath above the top plate of the unit. Four walls of the bath were made from acrylic plates and were attached to the metal top plate of the ultrasonic unit by silicon glue. The water layer in the bath created the medium for delivery of the power from all transducers located underneath the top plate of the unit to the sample. The water layer also enabled the uniform distribution of ultrasonic energy and adjustment of the intensity (W/l) of ultrasonic energy transmitted into the test sample contained in a cylinder inside the bath. A schematic picture of the experimental set-up is shown in FIG. 2.

Two types of cylinders were used, being 3 litre acrylic cylinders, and 500 ml glass cylinders. To ensure reproducible experimental conditions, the cylinders with slurry were placed in a fixed position on the top plate of the unit.

The conditions adopted for System 1 (see below) were a 3 litre acrylic cylinder with 1 litre of water added into the pad unit bath. The conditions adopted for System 2 (see below) were both acrylic and glass cylinders for bench top tests. Acrylic cylinders were placed in the bath with 1 litre of water added, and glass cylinders were placed in the bath with 2 litres of water.
System 1—Unimin clay Q38 was prepared as a 2 wt % suspension in 0.01M KCl. Natural pH of the slurry in the experiment was 7.6. Anionic flocculant SNF AN910 was used for flocculation at the dosage of 65 g/t to achieve the target settling rate of 10 m/h.
System 2—Unimin clay Snobrite was prepared as an 8 wt % suspension in 0.01 M KCl. Natural pH of the slurry in experiments was 8.8. Anionic flocculant SNF was used at the dosage 65 g/t in experiments conducted in acrylic cylinders and 80 g/t in experiments conducted in glass cylinders to achieve clear supernatant.

The conditions adopted for System 3 (see below) included the use of glass cylinders. Anionic flocculant SNF TC2050 was used for flocculation at the dosage of 19 g/t to achieve the target settling rate of 6 m/h.
System 3—Escondida tailings sample was prepared as 5.6 wt % (target 6 wt %) in synthetic process water. From chemical analysis of the processed water from Escondida mine (Table 1) chemical composition of the synthetic process water is as follows (Table 2).

TABLE 1
Chemical composition of the process water - Escondida mine.

| | Sample Description | | | | | | | | |
|---|---|---|---|---|---|---|---|---|---|
| | Cl | NO3 | PO4 | SO4 | Ca | K | Mg | Na | Mn |
| | mg/L | mg/L | mg/L | mg/L | mg/L | mg/L | mg/L | mg/L | mg/L |
| Processed Water - | 2740 | 1330 | <2.6 | 2180 | 880 | 160 | 1.8 | 2500 | <0.001 |
| Escondida | | | | | | | | | |

TABLE 2
Calculated salts concentration in
the process water - Escondida mine.

| | mM/l | mg/l |
|---|---|---|
| NaCl | 55.23 | 3225.432 |
| NaNO3 | 21.5 | 1827.5 |
| CaCl2 | 22 | 2443.76 |
| MgCl2 | 0.07 | 6.671 |
| K2SO4 | 2.005 | 270.8755 |
| Na2SO4 | 20.695 | 2462.705 |
| NaOH | 11.275 | 451 |

For the conducting of the settling tests, standard sample preparation and flocculation procedures were used. After the introduction of flocculant, a rake was inserted into the cylinder when hindered settling started. This time was found from separate settling tests without a rake for each system. In System 1, the rake was introduced after 2 min 30 s and in System 2 after 1 min 10 s of settling. The cylinder was then placed in the pad unit bath and the ultrasonic unit was turned on while the raking still continued.

Bed density was measured after 1 hour of raking, shaking the cylinder to obtain a flat mud line surface (the “settled bed level”). A Vernier Caliper (micrometer) was used to measure the bed level four times at each π/2 radian to calculate the bed density.

### Experimental Setup—Power Selection

Levels of power to be applied to the settling suspension after flocculant addition were found from separate experiments. After the suspension was flocculated and settled, different levels of ultrasonic energy were applied to the cylinders. The objective of these tests was to determine the level of ultrasonic energy that just breaks the network without redispersing the kaolin particles from the aggregates, which as mentioned above is generally referred to herein as being an “effective” amount. The effective amount was judged to be the power required to release inter-aggregate water while raking without significant restructuring of the aggregates, which will be understood to be different in different thickeners and systems, tending to be dependent upon time of treatment, solids, type of clay, and material of container.

### System 1

Results of the pad unit application to the 2 wt % of Q38 suspension are shown in Table 3. These results suggested that application of the ultrasonic sonotrode at its Power Level 2 can result in dispersion after 3 minutes of treatment. Therefore selection of Power Level 2 can be satisfactory under conditions of short time treatment. In this respect, the calculated intensity for Power Level 2 was 2.01 W/l. Power Level 5 was used as reference point to compare the influence of the higher power level change to the settling suspension behaviour.

TABLE 3
2 wt % Q 38 Settled bed

| Ultrasonic | Ultrasonic | |
|---|---|---|
| power level | duration | Settled bed status |
| 5 | 15 s | Quickly dispersed |
| 4 | 30 s | Quickly dispersed |
| 3 | 75 s | Very cloudy supernatant after 1 min |
| 2 | 180 s | No obvious change at the beginning, |
| | | a slight mist of dispersed kaolinite |
| | | can be observed at the top of settled |
| | | bed at around 3 mins. |

### System 2

Results of the pad unit application to the 8 wt % and 2 wt % of Snobrite suspension are shown in the Table 4. The 2 wt % suspension showed response to the ultrasonic treatment beginning from Power Level 3. No bed disturbance was observed in the higher 8 wt % suspension at all levels from Power Levels 1 to 7 consistent with the higher mass load. A turbid layer at Power Level 9 after 30 seconds showed that dispersion had started in the suspension.

TABLE 4
2 wt % and 8 wt % Snobrite bed - Acrylic cylinders.

| | | |
|---|---|---|
| Ultrasonic | Ultrasonic | Settled bed status |

| power level | duration | | 2 wt % | 8 wt % |
|---|---|---|---|---|
| 1 | 10 | min | No changes | No changes |
| 3 | 20 | s | Some particles | No changes |
| | | | shaking | |
| 5 | 10 | s | Some bubbles | No changes |
| 7 | 2 | min | Rising stream of | No changes |
| | | | clay particles | |
| | | | from the bed | |
| 9 | 30 | s | | Turbid layer |
| | | | | above the bed. |

These results suggest that all levels from Power Levels 1 to 7 could be used for ultrasonic treatment of the 8 wt. % suspension in the acrylic cylinder. At the same time, the use of ultrasonic treatment at Power Level 2 in the 8 wt % Snobrite suspension in an acrylic cylinder resulted in a decrease of bed density even after short times. The possible reason for this is that the acrylic cylinder produces high attenuation for ultrasound energy and, as a result, uneven distribution of the power in the sample. The obtained data suggested that vessels other than acrylic material, e.g. glass, would be better used for the tests with high solids suspensions. Taking into account that glass produces less attenuation of the ultrasonic waves, similar experiments were conducted in glass cylinders (500 ml, Pyrex) (Table 5).

TABLE 5
8 wt % Snobrite bed - Glass cylinders.

| Ultrasonic | Ultrasonic | |
|---|---|---|
| power level | duration | Settled bed status |
| 1 | 2 s | Many bubbles rising from the bed |
| 2 | 27 s | Turbid layer 2 mm thick was observed |
| | | on the top of the bed |
| 3 | 30 s | Turbid layer 3 mm thick was observed |
| | | on the top of the bed |
| 4 | 30 s | Turbid layer 5 mm thick was observed |
| | | on the top of the bed |
| 5 | | Turbid layer 10 mm thick was observed |
| | | on the top of the bed |

The results obtained suggested that the most suitable level of ultrasonic application to the 8 wt % suspension in glass cylinders is Power Level 1 which corresponded to 5.9 W/l. Higher levels were shown to disperse the system.

This experimental work indicated that Power Level 2 could be satisfactory under conditions of short time treatments for 2 wt % Q38 suspension in Perspex cylinders, that 2 wt % Q38 can be dispersed easier then 8 wt % Snobrite (probably due to the structural differences between these two kaolinites), and that Power Level 1 would be appropriate to use for treatment of the 8 wt % Snobrite suspension in glass cylinders. The experimental work also indicated that acrylic cylinders are not recommended for use for experiments with ultrasonic treatment of high solids suspensions. Usage of glass cylinders for high solids suspension is more appropriate.

### Determination of Location of Hindered Settling Zone and Transition Zone

In order to illustrate how to locate the transition zone, an acrylic cylinder with inner diameter of 85 mm was used, within which 2500 g of 2 wt % slurry was flocculated by AN910 flocculant. The initial mud line height (the settled bed level) was 440 mm.

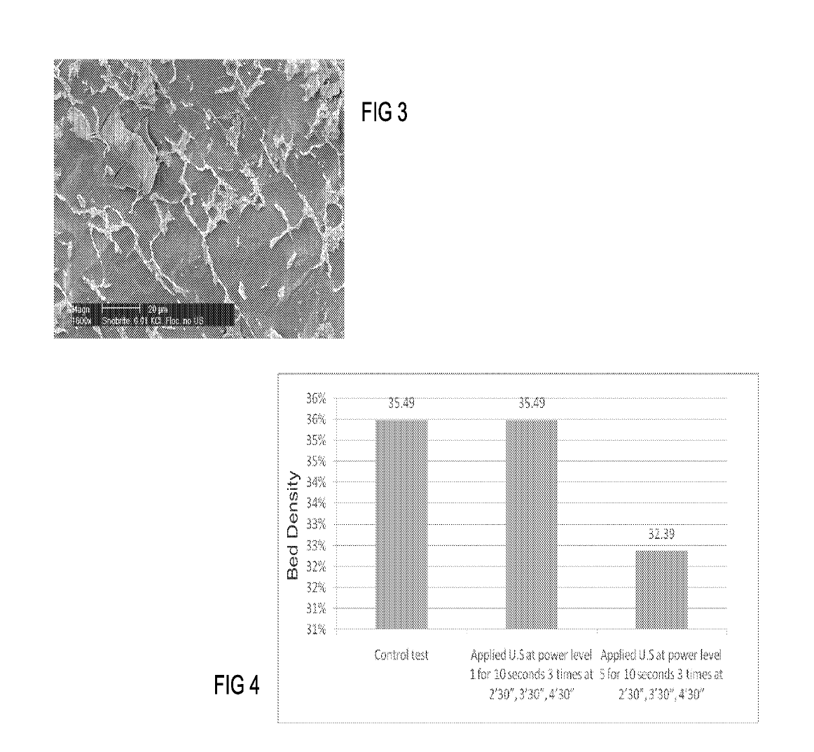

After the flocculant was introduced, with flocculant polymer binding on the kaolinite surfaces, the kaolinite aggregates and flocs size started to grow and settling began. A clear water and mud separation line could be observed. This mud line height was monitored every 5 s and a plot of mud line height versus settling time was generated and is shown in FIG. 3.

After flocculant was introduced, the size of aggregates grew very quickly during a short period of induction time (<10 s). When the aggregates were big enough, individual aggregates and flocs started to settle freely in settling zone 1. A linear relationship of mud line height and settling time was found in the first 2.5 min settling in settling zone 1 with a gradient of k₁ representing the settling rate. As the separate aggregates and flocs settled towards the bottom of the cylinder, contact between the aggregates and flocs resulted in a self-supporting network structure during 2.5 to 6 min of settling in settling zone 2. The settling rate k₂ in settling zone 2 was slower than k₁ due to the inter-aggregate/floc network-forming. From 6 to 20 min period, the gradient (k₃) of linear settling decreased significantly in settling zone 3 as most of the trapped water was largely released by raking and a denser self-supporting network was forming at this stage. After 20 min of settling, the mud line height became stable in settling zone 4 as the sediment was relatively compacted.

By monitoring the settled bed level (being the mud line height), the settling bed density could be calculated and another graph (not illustrated) of settled bed density as a function of mud line height could be plotted.

As shown in FIG. 3, the change of the gradient of the curve indicates the change of the settling zone and therefore four different settling zones could be identified. Settling zone 1 has the fastest settling rate as aggregates and flocs are settling separately without interference. Settling zone 2 is described as the hindered settling zone as aggregates and flocs form self-supporting network structures with some lateral bridging hindering the settling. Settling zone 3 is described as the transition zone and represents a transition period within the hindered settling zone and between it and the consolidation or compression zone. In the transition zone, a denser self-supporting network is formed but the sediment is not yet fully compacted.

The point where the tangent of the hindered settling zone (zone 2) and the transition zone (zone 3) meets is a transition point and represents the commencement of the transition zone. The point where the tangent of the transition zone (zone 3) meets the compression zone (zone 4) is generally regarded as the boundary between the hindered settling zone and the compression zone and is normally the location of the settled bed level. The compression zone (zone 4) is often described as the consolidation zone and is where the sediment has become fully compacted and water is locked in the complex void structures between particles.

### Comparative Example 1

### Ultrasonic Treatment at Top of Hindered Settling Zone

After the addition of flocculant, but without ultrasonic treatment, in the hindered settling zone, concentration of the suspension increases causing interference between individual flocs and formation of the network. This process slows down the settling rate. The structure of flocs, which were taken from the hindered settling zone, is illustrated in the Cryo-SEM image of FIG. 4.

In relation to the taking of the Cryo-SEM image in this, and the other examples, a drop of flocculated sample was mounted onto the top of a copper tube with an inner-diameter of 2 mm. This copper tube was fixed on a sample holder and plunged into liquid nitrogen under vacuum at 80 K to allow instant freezing, the small volume of sample and instant freezing minimizing the shrinkage and distortion of the sample. The sample was then transferred under vacuum to a sample preparation chamber equipped with an Oxford Cryo-transfer and fracture stage. The frozen sample was fractured to expose a fresh surface, then the chamber temperature was raised to 175 K to sublimate vitrified water at 6 nm/sec for 1 minute. This sublimation process removes the vitrified water crystals generated during fracture, allowing the flocs structure to stand above the level of the vitrified water.

An estimated 96 nm depth of vitrified water was sublimated. The sublimation time was just enough to expose the internal flocs structure and retain the integrity without collapse of the flocs structure. The sample was eventually coated with platinum for 3 minutes to avoid charging during the imaging process, before being imaged by a PHILIPS XL30 field emission gun scanning electron microscope.

Returning to the example, for System 1, after flocculant addition, the rake was inserted early during the period of hindered settling (see Point 1 in FIG. 1) at 2 min 30 s, and ultrasonic energy was applied for 10 seconds at each of the following time intervals: 2 min 30 s, 3 min 30 s, 4 min 30 s, at Power Levels 1 and 5. After application of the ultrasonic energy, raking was continued for 1 hour and then the bed height was measured to calculate the bed density (see FIG. 5).

As can be seen from FIG. 5, there was a general trend of decreasing bed density as the ultrasonic power level and time increased. Application of the ultrasonic energy towards the top of the hindered settling zone thus indeed opens the closed network, partially dispersing the aggregates, but the closed network tends to re-form before bed formation. The re-forming network appears to have larger trapped volumes leading to the diminishing effect of aggregates' self weight compression during the final compression zone, which is not ideal.

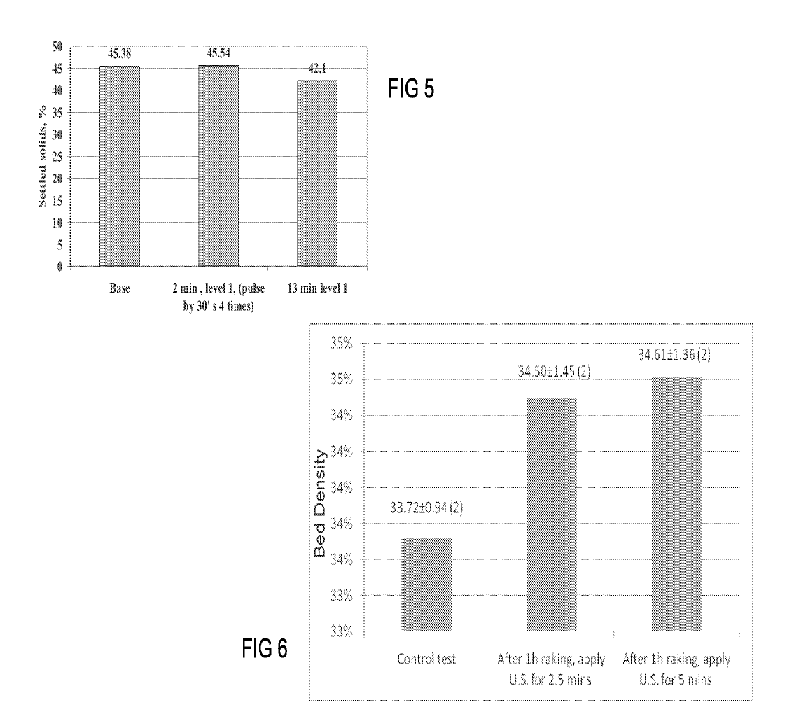

For System 2, the ultrasonic treatment was again applied early in the period of hindered settling, this time in four pulses of 30 seconds each starting at 2, 3, 4, and 5 minutes (in total 2 minutes of treatment) after flocculant introduction with continuous raking from 2 min. In a separate experiment, ultrasonic energy was administered to the system for 13 minutes starting at 2 minute of settling. In both cases, the power level was Power Level 1. The experiments were conducted in acrylic cylinders, and the settled solids densities in both experiments are shown in FIG. 6.

As can be seen, after four 30-second pulses (in total 2 minutes) of ultrasonic treatment, the settled solids density slightly increased from 45.38% (baseline) to 45.54% (2 minutes treatment), but this increase might be insignificant because the usual error base for this type of experiment is higher than the difference between results—0.16%. The longer treatment for 13 minutes actually resulted in the decrease of the settled solids density from 45.38% to 42.10%. This result may be attributed to the improved dispersion of the system after the longer ultrasonic treatment which led to the reduced effect of self-weight compression of separate particles and lower bed density, which again is not preferred.

In conclusion, both systems (System 1 and System 2) showed a general trend of reduced bed density (or at least not greatly improving bed density) as the time of ultrasonic treatment in the hindered settling zone increased. The tests conducted in the 2 wt. % Q38 suspension under Power Levels 2 and 5 showed that an increase of the ultrasonic energy also led to decreased bed density. The low Power Level 2 ultrasonic treatment may be insufficient to open enough of the closed clay suspension cellular structure network. The higher Power Level 5 appeared to disperse the flocs and aggregates into smaller aggregates, and possibly even single particles, in the hindered settling zone but re-formation tended to occur before bed formation without an increase in the effect of the aggregates' self weight compression during the final consolidation zone. In general, application of the ultrasonic treatment early (or higher up) in the hindered settling zone resulted in only a small response or indeed decreased (rather than increased, which is preferred) the bed density for both systems.

### Comparative Example 2

### Ultrasonic Treatment within the Compression Zone

After the system passes the transition zone within the hindered settling zone (and thus the boundary of the hindered settling zone and the compression zone), the settled bed level drops only very slowly and almost becomes stable. The settled bed is consolidating in the compression zone. In the compression zone, raking will push the smaller flocs forward as the rake moves, causing the re-arrangement of the flocs structure from E-E into F-F. However, analysis of Cryo-SEM images of the raked bed showed that there is still a significant amount of water trapped in the honeycomb cellular network structure. Thus, the purpose of this comparative experiment on application of the ultrasonic treatment to the compression zone was to investigate whether the application of ultrasonic energy would be able to assist further compression of the thickener underflow.

For System 1, ultrasonic treatment was applied to the settled bed after 1 hour. Settling tests were conducted in 6 separate cylinders. Tests were conducted in series: no ultrasonic treatment (cylinders number 1 and 4), 2.5 minute treatment (cylinders number 2 and 5), and 5 minute treatment (cylinders number 3 and 6). After ultrasonic treatment, raking continued for 10 minutes more and finally bed height was measured to calculate the bed density. The control test was raked for the same total time duration. This ultrasonic treatment was expected to rearrange bed structure without significant re-dispersion.

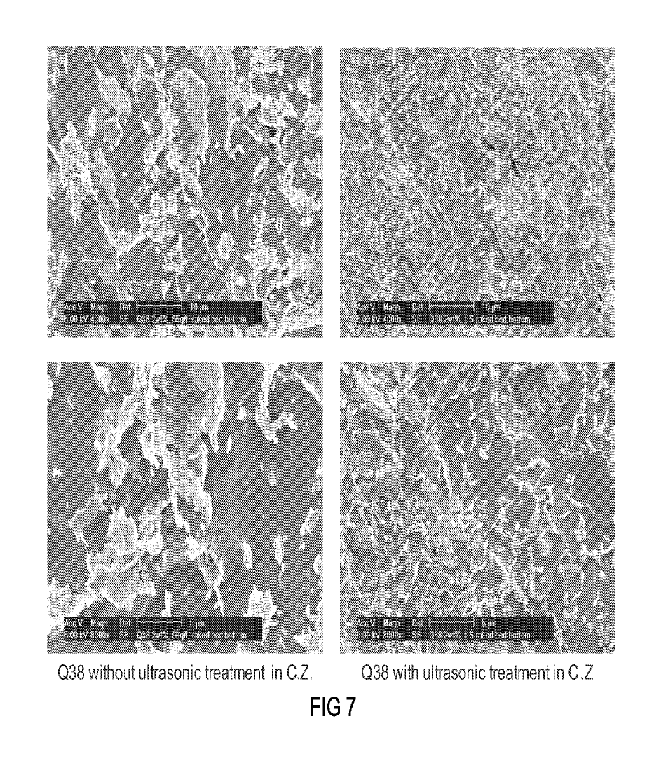

Referring to the results provided in FIG. 7, a limited increase of bed density by 0.9% only was observed in the suspension after 5 minutes at Power Level 2 ultrasonic treatment. It is also noticed that the error bars for the 2.5 and 5 minute experiments overlapped, so that no statistical average improvement of the bed density was observed.

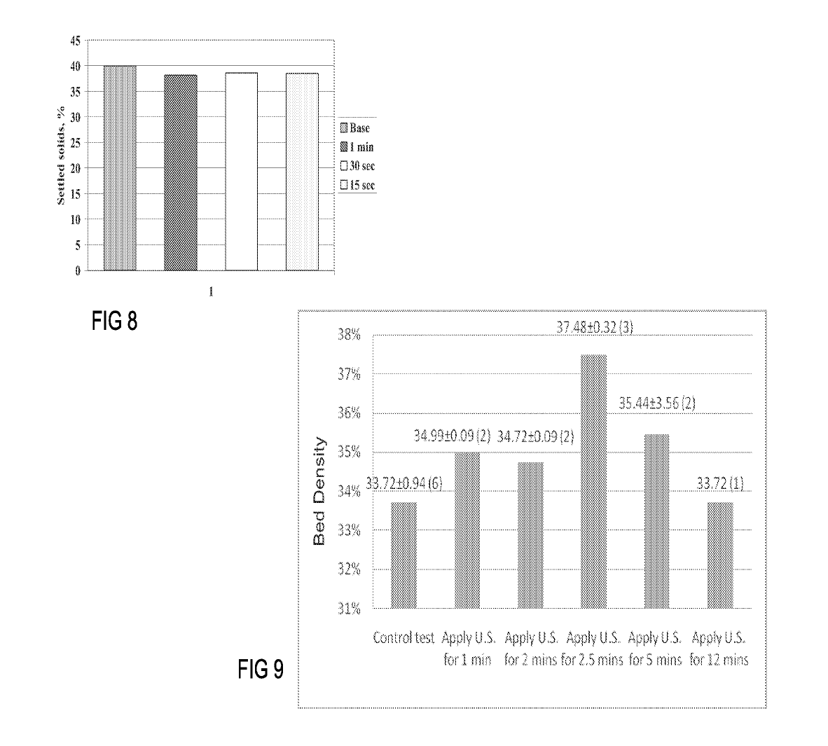

The Cryo-SEM images of FIG. 8 (where the control test is shown in the left column and the ultrasonic treatment for 5 minutes after 1 hour raking is shown in the right column) show that applying ultrasonic energy after 1 hour raking, for 5 minutes duration, dispersed some large aggregates into smaller aggregates, which contacted each other and formed the closed network again without significant release of trapped water.

These results suggest that after 1 hour raking and consolidation, the bed density reaches a threshold which is beyond the capability of the aggregates' self-weight to further compress, even if network breakage is induced by ultrasonic action. Hence, no statistical improvement of the bed density was found. These results also indicate that the trapped inter-aggregate water must be released quickly before the settled bed is fully consolidated to achieved desired higher bed density.

For System 2, ultrasonic energy was applied to the consolidated bed at Power Level 1 after 1 hour raking for 1 min, 30 and 15 sec with continuous raking. Some of the supernatant water was removed from the cylinders before the ultrasonic treatment to reduce re-dispersion. The results are shown in FIG. 9.

Ultrasonic treatment of the settled bed, even with lowest power and short time, led to some restructuring of the aggregates and, as a result, a decrease of the bed density by up to 2.8%. A possible reason for this may be that the decrease of the volume in the cylinder increased the intensity (W/l) of the ultrasonic treatment, and as a result re-incorporation of water into the re-forming network of the floc system.

The results for Comparative Example 2 showed that application of ultrasonic energy to the compression zone of the settled bed did not produce significant improvement and even led to some water re-incorporation into the floc network of the system. The results suggest that, after 1 hour raking and consolidation, the bed density will reach a threshold for the aggregates' self-weight to compress the settled bed. Hence, the breaking of the flocs structure will not further consolidate the settled bed unless water can be extracted simultaneously. This is not achieved by the action of the rake alone. It is also possible that the re-formed structure is sufficiently strong that the ultrasonic energy can only effectively break clay aggregate networks near the borders of the network due to attenuation.

### Example 1

### Ultrasonic Treatment in the Transition Zone within the Hindered Settling Zone

When settling reached Point 2 in FIG. 1, the settled bed was mostly solidified by raking and the flocs were forming a self-supporting honeycomb structure. In order to collapse this self-supporting structure and further compress the flocs, ultrasonic treatment was applied at an effective power level, being a power level just below the power level which first disperses the settled bed. The ultrasonic treatment was applied with continuous raking.

For System 1, based on the results of the above power level testing, the ultrasonic treatment was applied at Power Level 2 (with a calculated intensity of 2.01 W/l in the acrylic cylinder) after 10 minutes of raking. The ultrasonic duration varied from 1 min to 12 min.

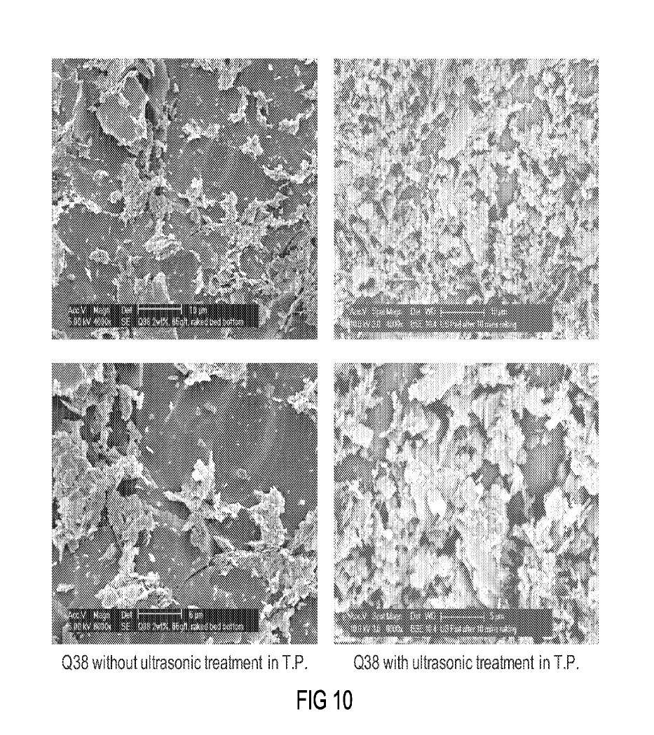

The results of the application of the ultrasonic treatment in the transition zone showed strong dependence on time. The bed density increased by up to 3.76% after 2.5 minutes of treatment (see FIG. 10, where the numbers in brackets indicate the number of tests done for each condition). The application of longer times resulted in a decrease of the bed density likely due to dispersion of the clay aggregates as a result of more energy input. Therefore, 2.5 min appears to be the optimized duration of ultrasonic treatment for System 1. This treatment collapsed the network without dispersing the aggregate, and opened the smaller flocs to help further water release from the closed structure. In this respect, it will be appreciated that different thickeners and thickener systems (and slurries and liquids) will likely have different optimum durations for ultrasonic treatments.

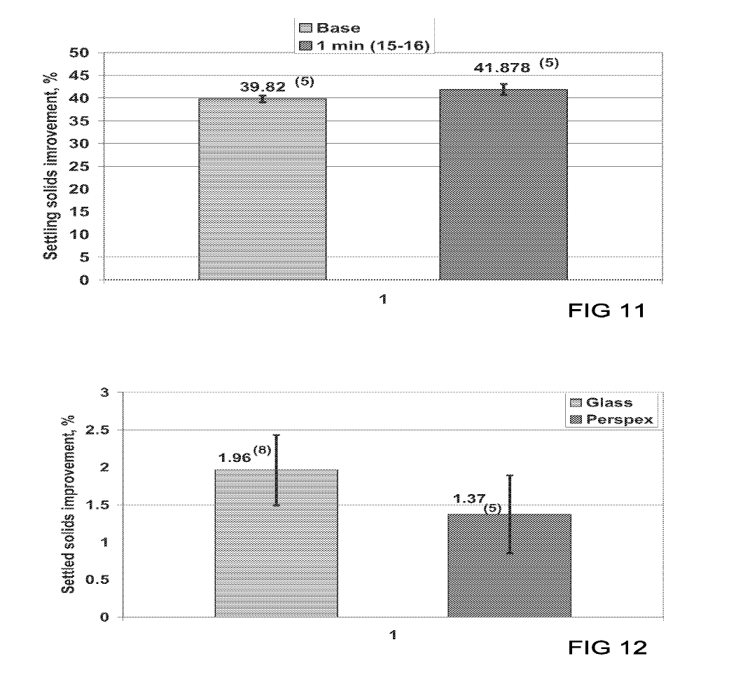

The Cryo-SEM images in FIG. 11 (where the control test is shown in the left column and the right column is after ultrasonic treatment for 2.5 minutes after 10 minutes of raking) show that applying ultrasonic energy in the transition zone collapses some of the self-supporting structure, resulting in a much denser structure.

These results suggest the proper power level and duration of ultrasonics can just break the self-supporting networking without dispersing the aggregates. After this self-supporting structure collapse, the rake can release the water immediately when the flocs are opened in the transition zone resulting in bed density improvement.

In System 2, application of the ultrasonic treatment to the suspension in glass cyclinders was conducted at Power Level 1. The ultrasonic treatment was again applied in the transition zone for 1 minute starting from 15 minutes and ending at 16 minutes of the settling test. Test results showed that the ultrasonic application for 1 minute led to the increase of the average bed density by 2.06±0.47%.

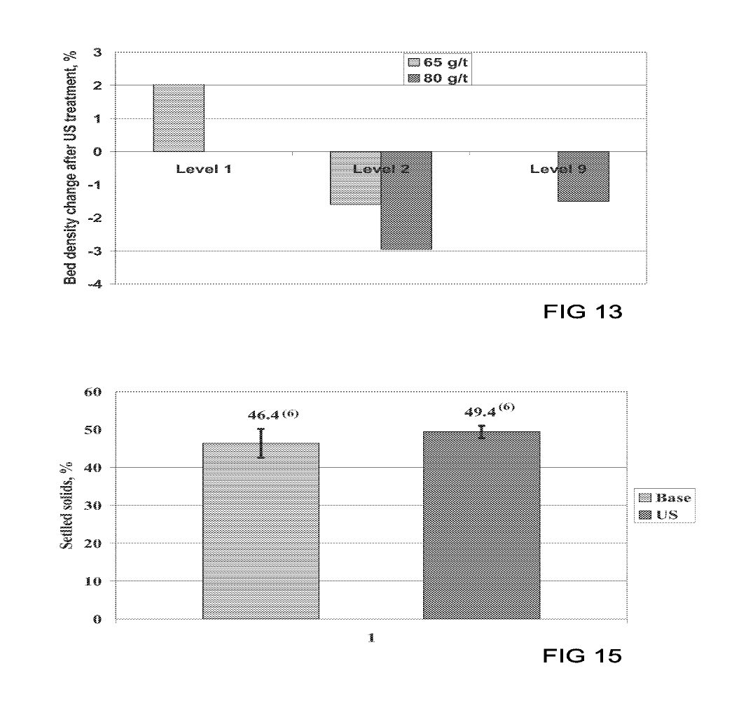

The results are shown in FIGS. 12 and 13, where again the numbers in brackets indicate the number of tests done for each condition. Increasing the ultrasonic application time to 2 minutes of treatment resulted in a decrease of the bed density. The optimised time for ultrasonic treatment under described conditions is thus likely to be less than 2 minutes. Referring particularly to FIG. 13, although the glass cylinders showed better performance with ultrasonic treatment, initially tests were conducted in acrylic cylinders. Results of the 1 minute treatment showed an average increase of settled solids by 1.37±0.52% with a lower average value than for glass cylinders.

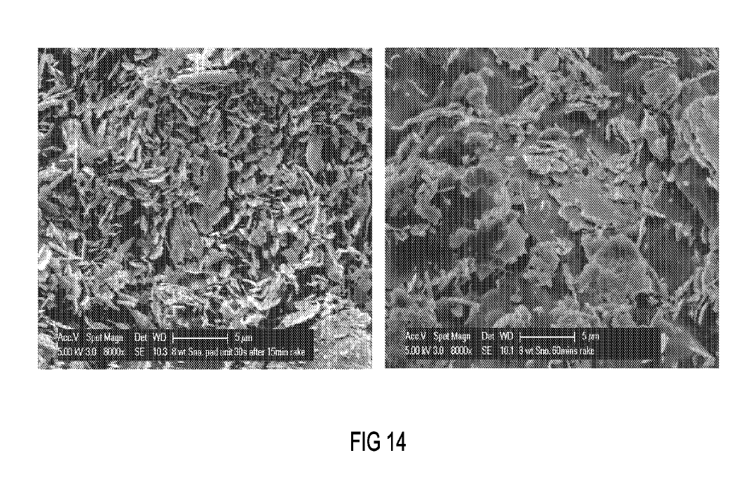

Also, application of the ultrasonic treatment at Power Levels 2 and 9 resulted in a decrease of the bed density (see FIG. 14). These results suggested that application of a power higher than Power Level 1 led to an undesirable dispersion of the system.

The Cryo-SEM evidence from the ultrasonic application for System 2 to the bed for 30 seconds during raking in the transition zone confirmed the formation of denser aggregates with less porous structure (see FIG. 15 where the right picture is the 8 wt % Snobrite Base-line test, and the left picture is after 30 s of pad unit application).

In relation to System 3 (being the Escondida tailings, not tested in either of the other Examples), application of the ultrasonic treatment to the 6 wt % Escondida tailing in glass cyclinders was conducted at Power Level 1. The treatment was also applied in the transition zone for 30 seconds starting from 20 minutes and ending at 20 min 30 s of the settling test. The test results are presented in FIG. 16 (again the number in the brackets indicates the number of tests done for each condition) and show that ultrasonic application for 30 seconds resulted in the increase of the average bed density by 3.02%.

In conclusion, the results for both the model clay systems (Systems 1 and 2) and the tailings sample (System 3) suggested that the most efficient method to improve bed density was to apply ultrasonic energy at an effective power level, being a power level that can just break the self-supporting network without dispersing the aggregates. After this self-supporting structure collapses and the flocs are opened, raking can further assist water release. Opening the closed network structure can facilitate the compression and make the settled bed more compressible (less resistance) which leads to the bed density improvement.

Finally, it must be appreciated that there may be other variations and modifications to the configurations described herein which are also within the scope of the present invention.

1. A gravity sedimentation process for the treatment of a slurry in a thickener to separate a solid from a liquid, the thickener having, at steady-state, a hindered settling zone and a compression zone, the process including the application of an effective amount of ultrasonic energy to the slurry in a transition zone within the hindered settling zone.

2. A process according to claim 1, wherein between the hindered settling zone and the compression zone is a boundary and the transition zone is adjacent the compression zone and immediately above the boundary.

3. A process according to claim 1 or claim 2, wherein the ultrasonic energy is applied only through the transition zone within the hindered settling zone, and not additionally through other zones.

4. A process according to claim 3, wherein the ultrasonic energy is applied from a sidewall of the thickener adjacent the transition zone.

5. A process according to claim 3, wherein the ultrasonic energy is applied by fixing ultrasonic transducers around the inside or outside of the sidewall at the height of the transition zone, the transducers being connected to a control unit which can adjust the power output of the transducer to a desired power density.

6. A process according to claim 5, wherein an immersible transducer is fixed inside the thickener.

7. A process according to any one of claims 1 to 6, wherein the intensity of the ultrasonic energy applied to the slurry will be in the range of 1.0 to 100.0 watts/litre (W/l).

8. A process according to any one of claims 1 to 6, wherein the intensity of the ultrasonic energy applied to the slurry will be in the range of 1.0 to 50.0 watts/litre (W/l).

9. A process according to any one of claims 1 to 6, wherein the intensity of the ultrasonic energy applied to the slurry will be in the range of 1.0 to 10.0 watts/litre (W/l).

10. A process according to any one of claims 1 to 9, wherein ultrasonic energy is applied at a frequency in the range of 20 to 450 Hz.

11. A gravity sedimentation process for the treatment of a slurry in a thickener to separate a solid from a liquid, the thickener having, at steady-state, a hindered settling zone and a compression zone, the process including the application of an effective amount of ultrasonic energy to the slurry in a transition zone within the hindered settling zone, wherein the application of an effective amount of ultrasonic energy to the slurry in the transition zone breaks a self-supporting structure of aggregates forming, before a honeycomb-like bridged network of edge-edge chains of solid particles fully consolidates in the compression zone.

12. A thickener for gravity sedimentation in the treatment of a slurry to separate a solid from a liquid, the thickener having, at steady-state, a hindered settling zone and a compression zone, the thickener including an ultrasonic generator for applying an effective amount of ultrasonic energy to the slurry in a transition zone within the hindered settling zone.

13. A thickener according to claim 12, wherein the ultrasonic generator is an ultrasonic energy transducer.

14. A thickener according to claim 12 or claim 13, wherein between the hindered settling zone and the compression zone is a boundary and the transition zone is adjacent the compression zone and immediately above the boundary.

15. A thickener according to any one of claims 12 to 14, wherein the ultrasonic energy is applied only through the transition zone within the hindered settling zone, and not additionally through other zones.

16. A thickener according to claim 15, wherein the ultrasonic energy is applied from a sidewall of the thickener adjacent the transition zone.

17. A thickener according to claim 16, wherein the ultrasonic energy is applied by fixing ultrasonic transducers around the inside or outside of the sidewall at the height of the transition zone, the transducers being connected to a control unit which can adjust the power output of the transducer to a desired power density.

18. A thickener according to claim 17, wherein an immersible transducer is fixed inside the thickener.

19. A thickener according to any one of claims 12 to 18, wherein the intensity of the ultrasonic energy applied to the slurry will be in the range of 1.0 to 100.0 watts/litre (W/l).

20. A thickener according to any one of claims 12 to 18, wherein the intensity of the ultrasonic energy applied to the slurry will be in the range of 1.0 to 50.0 watts/litre (W/l).

21. A thickener according to any one of claims 12 to 18, wherein the intensity of the ultrasonic energy applied to the slurry will be in the range of 1.0 to 10.0 watts/litre (W/l).

22. A thickener according to any one of claims 12 to 21, wherein ultrasonic energy is applied at a frequency in the range of 20 to 450 Hz.
